(19) United States
(12) Patent Application Publication
(10) Pub. No.: US 2009/0172678 A1
(43) Pub. Date: Jul. 2, 2009

(54) Method And System For Controlling The Functionality Of A Transaction Device

(75) Inventors: Frederick F. Branca, JR., Patterson, NY (US); Simon Blythe, Ely (GB); Sahra S. English, Yorktown Heights, NY (US); Jill E. Maitland, Rye Brook, NY (US); David A. Roberts, Appleton (GB); Julie M. Kramer, Tarrytown, NY (US); Alexander Antunovic, Astoria, NY (US); Jean-Paul Rans, Glabais (BE)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 12/343,601

(22) Filed: Dec. 24, 2008

Related U.S. Application Data
(60) Provisional application No. 61/017,363, filed on Dec. 28, 2007.

(51) Int. Cl. G06F 9/46

(52) U.S. Cl. 718/101

(57) ABSTRACT

A method and system of controlling the functionality of a transaction device, the method includes providing a computing device for accessing an account corresponding to the transaction device. The computing device generates a list of a plurality of transaction functions associated with the transaction device. The method includes providing an option to disable and enable one or more of the transaction functions in response to a user input. In response to the user input disabling one of the transaction functions, an instruction is generated preventing the transaction device from being used for the disabled transaction function.

This application claims the benefit of priority to U.S. Provisional Application 61/017,363 filed on Dec. 28, 2007 which is incorporated by reference herein in its entirety.

### FIELD OF THE INVENTION

The present invention relates to controlling a transaction device capable of performing a plurality of transaction functions and, more particularly, to controlling a transaction device by selectively disabling and enabling transaction functions.

### BACKGROUND OF THE INVENTION

Electronic payments and other transactions are fast becoming the manner for conducting consumer transactions around the world. Instead of using cash, consumers are using many different types of cards and devices to buy a wide range of items. These consumer transaction devices include, for example, credit cards, debit cards, gift cards, and prepaid cards for such items as gasoline and phone service. Transaction devices are also used to track consumer activities so that incentives may be given to the consumer in the form of a consumer loyalty program. Transaction devices such as credit and debit cards are typically issued by banks or other financial institutions. Retailers of goods and services also issue transaction devices.

Transaction devices typically use magnetic strips which maintain encoded information for authenticating and identifying the user of a card. In addition to a traditional magnetic strip that holds information, often these cards may further contain an embedded integrated circuit which can process information. A card including such an integrated circuit is often referred to as a smart card, chip card or integrated circuit card (ICC).

A single transaction device may be able to perform a variety of transaction functions such as credit card, debit card, loyalty card, phone card, etc. The device may also be used in a variety of geographical areas and be able to purchase a wide variety of goods or services. Such transaction devices also may permit a customer to participate in a loyalty program, since a merchant can track transaction activity and reward customers for their repeated business. When a transaction device is activated upon receipt by the holder, all the functions typically become and remain active, allowing a user to benefit from the various features of the device.

While the use of transaction devices provides a significant convenience to customers and merchants, these devices are subject to fraudulent activity. One type of fraud is known as skimming. Skimming fraud takes many forms, but most often involves a cardholder turning over physical possession of his or her card to a retail or restaurant employee, who then swipes the card through a small, illegal card reader called a “skimmer.” The skimmer copies the data encoded on the card's magnetic stripe. This information is then used to manufacture counterfeit cards which are used to make illegal charges. Skimming may also include corrupting legitimate card payment terminals by way of a virus such that sensitive information is misdirected. Once the account information has been fraudulently obtained, it can be used to access all the functions of the device.

Even when a customer desires only to use the transaction device for loyalty program purposes and not for financial purposes, the transaction device is subject to be used for all financial transactions with or without the consent of the owner. Therefore, the device is subject to fraudulent use which could have a significant financial impact.

Accordingly, it would be desirable to provide a method and system for a holder of a transaction device to control a transaction device to selectively disable and enable transaction functions.

### SUMMARY OF THE INVENTION

The present invention provides a method and system of controlling the functionality of a transaction device.

The present invention further provides a method of controlling the functionality of a transaction device, the method includes providing a computing device for accessing an account corresponding to the transaction device. The computing device generates a list of a plurality of transaction functions associated with the transaction device. The method includes providing an option to disable and enable one or more of the transaction functions in response to a user input. In response to the user input disabling one of the transaction functions, an instruction is generated preventing the transaction device from being used for the disabled transaction function.

The present invention further provides a method of performing a commercial transaction including receiving a transaction instruction generated by a transaction terminal; comparing the transaction instruction to a customer modifiable list of transaction functions; and providing a transaction authorization response based on the comparison.

The present invention still further provides a commercial transaction system including a transaction device for initiating a commercial transaction. A terminal for processing an instruction responsive to the transaction device is included. The instruction includes a transaction function request. A transaction authorizer is in operative communication with the terminal. The transaction authorizer includes a database corresponding to the transaction device. The database has a plurality of transaction functions adapted to be selectively enabled and disabled by a user. The transaction authorizer including a comparator for comparing the transaction function request to the plurality of transaction functions. The transaction authorizer generates a transaction response responsive to the comparison.

### BRIEF DESCRIPTION OF THE DRAWINGS

FIG. 1 is a schematic representation of a system of the present invention.

FIG. 2 is a flow diagram of a method of the present invention.

FIG. 3 is a flow diagram of a further method of the present invention.

FIG. 4 is a flow diagram of an alternative embodiment of the present invention.

### DETAILED DESCRIPTION OF THE PREFERRED EMBODIMENTS

The present invention relates to a method and system for controlling the functionality of a transaction device. The transaction device may include a card, wand, phone, transponder or any device having a magnetic strip and/or a chip or other element which may be used to perform a commercial transaction such as purchasing items or services or participating in a customer loyalty program and the like. The transaction device may be able to perform one or more transaction functions such as credit, debit, loyalty program, cash, and a prepaid function such as a gas, phone, or gift card. This list of transaction functions is for exemplary purposes and not intended to be limiting.

With reference to FIG. 1, a system 5 includes a transaction device 10 having an active portion 12. The active portion 12, which is supported on the transaction device, may contain identification information corresponding to a particular account(s). The identification information may be in the form of a primary account number or PAN. The active portion 12 may be in the form of a magnetic strip, a chip, RFID or other information storage device of a type such as those known in the art. The transaction device 10 is adapted to communicate with a point of sale device or terminal 14 of a type well known in the art. Such terminals 14 may be located adjacent to a cash register or be integrated therewith. Upon conducting a transaction, the active portion 12 is interrogated by a reader portion 15 of the point of sale terminal and the identification information is obtained so that the transaction can be linked to the identification information. The point of sale terminal 14 may be operably connected to a transaction processing network 16 such as the MasterCard® network. Through the network 16, the terminal 14 is operably connected to a transaction authorizer 18. The authorizer 18 may be a financial institution which issues the transaction device or other institution which provides authorization for a transaction conducted by the transaction device 10. The transaction authorizer 18 may include a computing device 19 having a database which stores in memory information about the various accounts. The computing device 19 may include one or more computers or network of computers and related hardware and software. The computing device 19 is operably connected to the transaction processing network 16.

The transaction authorizer 18 may be in operable communication with a user access device 20. The user access device 20, which may be in the form of a telephone or internet connected device such as a personal computer, permits a user of the transaction device to communicate remotely with the transaction authorizer 18. The user access device 20 permits a user to whom the transaction device is issued, also referred to as a holder, to remotely access their account and modify the functionality of the transaction device. Upon accessing the account, the computing device 19 of the transaction authorizer may generate a list of transaction functions associated with the account.

The holder or user of the transaction device 10 may selectively disable, and/or enable/re-enable one or more of the transactional functions as desired. Such a feature assists in preventing unauthorized uses of the transaction device. For example, a user may disable the credit function so that the transaction device 10 could not be used as a credit card. Alternatively, a user may disable the debit function so that the payment device could not be used as a debit card. Preferably, a user could disable one or more of the transaction functions as desired, such as both the credit and debit functions.

A user of the transaction device may also disable/enable a function in manner that restricts or partially limits operability of a particular function or functions. Accordingly, enabling or disabling may also include placing restrictions on the transaction device. For example, the transaction device 10 may be restricted to be inoperable in a particular geographical area or region. A user may desire to disable the device 10 from functioning outside their country of residence. However, if the user is about to travel abroad, then the international functionality could be enabled. The maximum value of a transaction could also be restricted, such that a user could prevent the use of the transaction device 10 for expensive purchases. A spending limit of the transaction device could also be set. For the phone card function, a user could restrict its function to call only certain approved geographical areas or numbers. These examples are meant to be exemplary and not limiting as to the scope of the present invention.

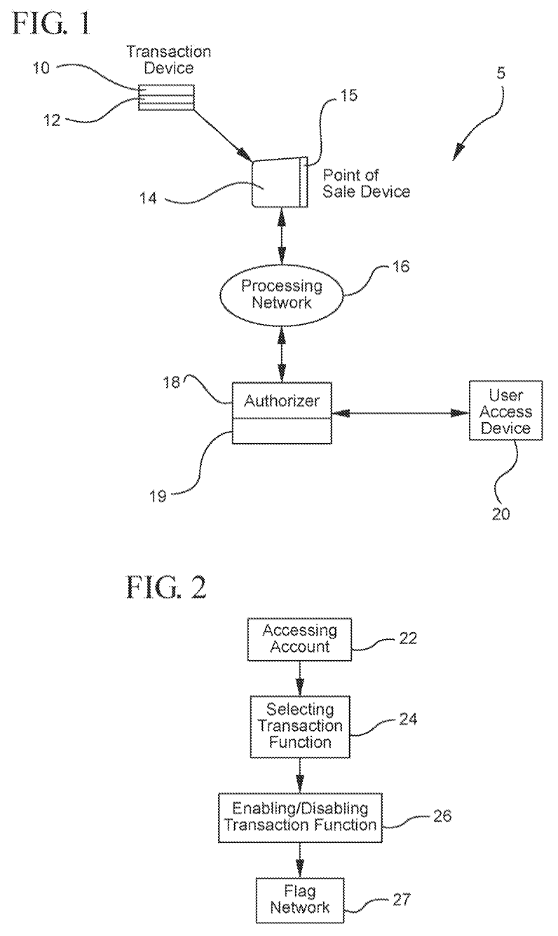

With reference to FIGS. 1 and 2, a method of the present invention allows a user to selectively disable or enable one or more of the various transaction functions of the transaction device 10. This is preferably achieved by use of the user access device 20 to communicate with the transaction authorizer 18 to access an account 22. The transaction authorizer 18 may be the issuer of the transaction device. The communication may be initiated telephonically wherein the user, preferably upon entry of a predetermined authorization code, gains access a computing device 19 on which is stored the user's account. Access to the account may also be gained via a computer over the internet upon connection to the authorizer's website and the computing device 19. Entry of an authorization code would preferably be required before the user could access the user's account information.

In one embodiment of the present invention, a user, whose transaction device in the form of a card issued by their bank, may go onto the bank's website and log on to their account information from their home computer. A link to the card may be provided on the user's account page, and the user may select from a list of possible transaction functions and choose which features to enable or disable.

Once access to the account associated with a particular transaction device is obtained, a user may be presented with a list of transaction functions which are permitted to be conducted in association with the transaction device. The user may then generate an input which selects the particular transaction function or functions that they wish to modify 24. The user may then disable/enable one or more of the functions 26. Depending on how the user interface is designed and the information is presented to the user, the steps of selecting and modifying the transaction function may be performed simultaneously. Modifications are stored in memory and will be maintained until the user makes a further change. Once a function is disabled, the transaction device will no longer be able to be used to conduct those types of functions.

In addition, upon receiving a new transaction device 10, such as a card, a user may proceed to the applicable portion of their bank's website, and upon accessing their account, activate the card and enable the desired features. In this embodiment, all features may be disabled until enabled by the user. Alternatively, the card could be set up to have all transaction functions enabled upon activation of the card, with the user disabling selected functions as desired. In either embodiment, the present invention permits a user to selectively and repeatedly enable and disable various transaction functions as desired.

Once the transaction authorizer 18 receives the request to disable a function, the request is matched to the PAN of the user's transaction device. The transaction authorizer may generate a signal or instruction such that the account number would then be flagged on the transaction processing network 27 so that an attempt to use a disabled transaction would be prevented. The transaction device 10 would be rendered inoperable for those disabled functions. A signal could then be generated at the point of sale terminal alerting the user of the failed transaction. The signal, for example, may be in the form of a “decline”, “sleep mode” or “feature disabled” message. The computing device 19 includes suitable software and hardware is provided to communicate to the processing network the enablement status of a particular transaction function.

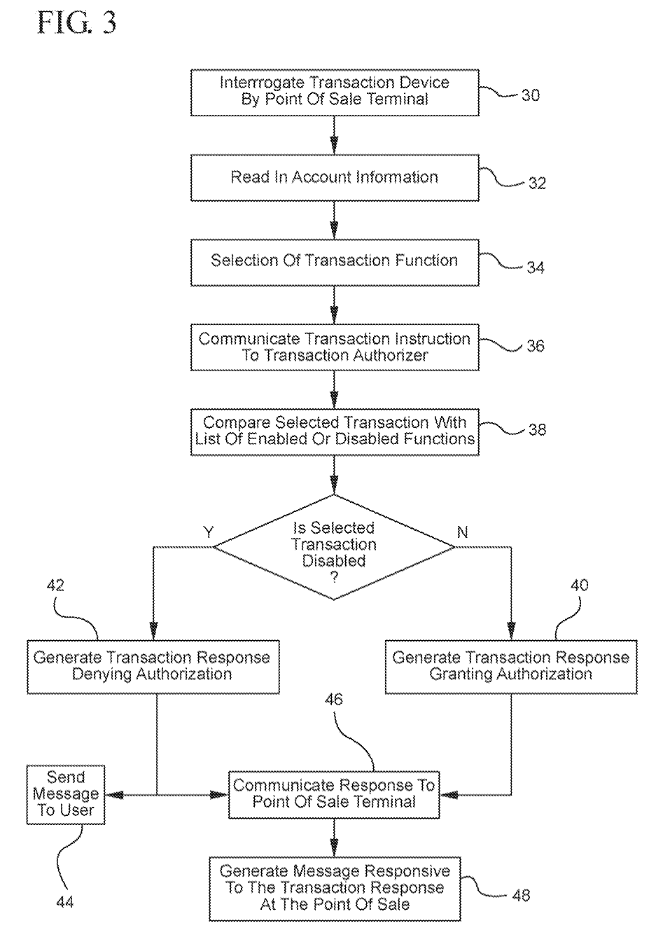

With reference to FIGS. 1 and 3, the various steps for performing a commercial transaction in accordance with the present invention will now be described. A transaction may begin with the user presenting the transaction device 10 such that it is interrogated by the point of sale device 30. The account identification information is then read in 32. A transaction function, e.g., credit, debit, etc, is then selected 34. The selection may be inputted by the user or may be predetermined by the type of transaction being performed. The transaction function and transaction details, e.g., sales total, generated at the point of sale, together form an electronic transaction instruction which is communicated over a processing network to a computing device 19 of the transaction authorizer to obtain authorization 36. The computing device accesses the account information of the user held in a database, and the requested transaction function is compared, by way of a comparator, to the user modifiable list of transaction functions for the particular account 38. If the particular requested transaction function is enabled, then a transaction response instruction is generated by the computing device granting authorization 40 for the transaction. However, if the transaction function is disabled, then a transaction response instruction is generated denying authorization 42. Alternatively, the transaction processing network after being flagged by the transaction authorizer of a disabled transaction function for a certain account may deny the authorization. A message could be sent to the user, 44, in the form of an e-mail, letter or phone call alerting them of the attempt to use the transaction device for a disabled function. The transaction response is communicated to the point of sale terminal 46 preferably over the processing network. An appropriate message responsive to the signal may be generated and displayed at the point of sale terminal 48.

The communication with the transaction authorizer may also determine other information such as whether the transaction amount exceeds a predetermined monetary limit or whether there are other transaction restrictions on the account. The authorization response to permit or deny the transaction may be influenced by such information.

Upon disabling a function, the identification information is flagged on the processing network, and any attempt to use the transition device for a disabled function will be prevented. The transaction device 10 may still be usable for conducting transactions that have not been disabled. Accordingly, if a transaction device is used as a loyalty card in addition to a financial card, the financial functions, e.g., credit and debit, could be disabled, but the card could still be used to accrue loyalty point or credits. When a user desires to re-enable a function, they may again communicate with the authorizer and preferably upon entry of an authorization code, re-enable the transaction function.

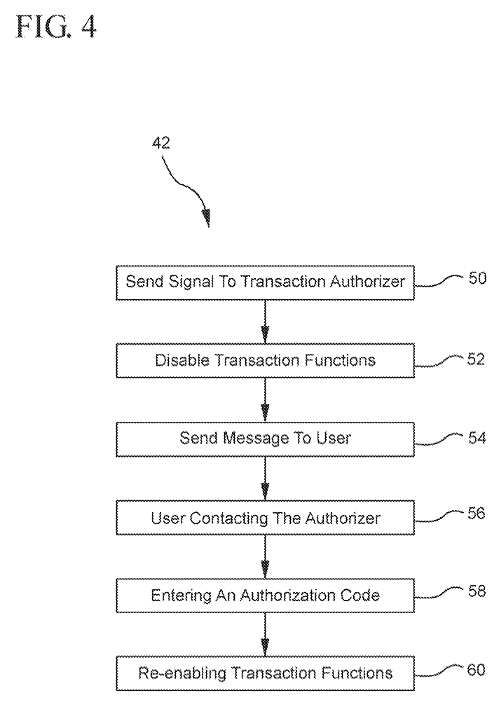

With reference to FIG. 4, in an alternative embodiment, in response to the attempt to use the transaction device 10 for an unauthorized function, a signal could be generated and send to the authorizer 50. Upon receipt of the signal the authorizer could cause all the transaction functions to be disabled 52. Therefore, in addition to denying authorization for that particular transaction, the transaction authorizer could then prevent all future transaction functions associated with the transaction device. A message would then be sent to the user alerting them of the disablement 54. A user would preferably have to contact the authorizer 56, for example, telephonically or over the internet, and upon entry of a proof of identify or an access code 58 request to have the transaction functions re-enabled 60 by the computing device of the authorizer. Accordingly, an improper use of the transaction device would require verification that the proper user is in control of the device. Alternatively, use of the transaction device for a disabled transaction would result in only certain of the functions being disabled, such as the financial functions.

A number of embodiments of the invention have been described. Nevertheless, it will be understood that various modifications may be made without departing from the spirit and scope of the invention. Also, the steps described above may be modified in various ways or performed in a different order than described above, where appropriate. Accordingly, alternative embodiments are within the scope of the following claims.

What is claimed is:

1. A method of controlling the functionality of a transaction device comprising:
providing a computing device for accessing an account corresponding to the transaction device;
the computing device generating a list of a plurality of transaction functions associated with the transaction device and;
providing a option to disable and enable one or more of the transaction functions in response to a user input; and
in response to the user input disabling one of the transaction functions, generating an instruction preventing the transaction device from being used for the disabled transaction function.

2. The method of claim 1, further including the computing device being in operative communication with a commercial transaction processing network.

3. The method of claim 1, further including providing remote access to the account information.

4. The method of claim 1, wherein the plurality of transaction functions is at least one of a debit, a credit, a prepaid, cash, and a loyalty function.

5. The method of claim 1, further including accessing the account corresponding to the transaction device and re-enabling the previously disabled transaction function.

6. The method of claim 1, wherein the computing device is accessible to a user via a telephonic device.

7. The method of claim 1, wherein the computing device is accessible to a user via a remote computer.

8. The method of claim 1, wherein the option to disable or enable includes partially limiting operability of the transaction function.

9. A method of performing a commercial transaction comprising:
receiving a transaction instruction generated by a transaction terminal;
comparing the transaction instruction to a customer modifiable list of transaction functions; and
providing a transaction authorization response based on the comparison.

10. The method of claim 9 further comprising interrogating a transaction device and reading in account information.

11. The method of claim 9 further comprising selecting a transaction function.

12. The method of claim 11 wherein providing a transaction authorization response includes generating a response denying authorization when the transaction function is disabled.

13. The method of claim 12 further comprising disabling all transaction functions when the transaction function selected is disabled.

14. The method of claim 11 wherein providing a transaction authorization response includes generating a response granting authorization when the transaction function is enabled.

15. A commercial transaction system comprising:
a transaction device for initiating a commercial transaction;
a terminal for processing an instruction responsive to the transaction device, the instruction including a transaction function request;
a transaction authorizer in operative communication with the terminal, the transaction authorizer including a database corresponding to the transaction device, the database having a plurality of transaction functions adapted to be selectively enabled and disabled by a user, the transaction authorizer including a comparator for comparing the transaction function request to the plurality of transaction functions, and the transaction authorizer generating a transaction response responsive to the comparison.

16. The system of in claim 15, wherein the transaction device includes an active portion in selective operable communication with the terminal, the active portion including account identification information.

17. The system of in claim 15, wherein the transaction response is configured to authorize the transaction when the comparison determines that the transaction function is enabled.

18. The system of in claim 15, wherein the transaction response is configured to not authorize a transaction when the comparison determines that the transaction function is disabled.

19. The system of in claim 15, further including a transaction processing network operably connected to the terminal and a transaction authorizer, the network adapted to transmit the instruction to the transaction authorizer.

20. The system of in claim 15, further including a user access device for permitting the transaction functions to be selectively enabled and disabled.
